(19) United States
(12) Patent Application Publication
(10) Pub. No.: US 2008/0213646 A1
(43) Pub. Date: Sep. 4, 2008

(54) Proton-conductive composite electrolyte membrane and producing method thereof

(75) Inventors: Toshihiro Takekawa, Yokosuka-shi (JP); Hiroyuki Kanesaka, Sumida-ku (JP); Kiyoshi Kanamura, Hachioji-shi (JP)

Correspondence Address: FOLEY AND LARDNER LLP;SUITE 500, 3000 K STREET NW, WASHINGTON, DC, 20007, US

(73) Assignees: Kiyoshi KANAMURA; NISSAN MOTOR CO., LTD.

(21) Appl. No.: 12/081,551

(22) Filed: Apr. 17, 2008

Related U.S. Application Data
(62) Division of application No. 11/252,542, filed on Oct. 19, 2005.

(30) Foreign Application Priority Data
Oct. 20, 2004 (JP) 2004-305631
Feb. 25, 2005 (JP) 2005-050269

(51) Int. Cl. H01M 8/10

(52) U.S. Cl. 429/33

(57) ABSTRACT

A composite electrolyte membrane of the present invention includes a porous body composed of an inorganic substance and an electrolyte material. The porous body includes therein plural spherical pores in which a diameter is substantially equal, and communicating ports each allowing the spherical pores adjacent to each other to communicate with each other. The electrolyte material is provided on the spherical pores and the communicating ports, has proton conductivity, and is composed of a hydrocarbon polymer. The proton-conductive composite electrolyte membrane has excellent ion conductivity, high heat resistance, and restricted swelling when being hydrous, and is capable of being produced at low cost.

### BACKGROUND OF THE INVENTION

1. Field of the Invention

The present invention relates to a composite electrolyte membrane having proton conductivity and to a producing method thereof, and more specifically, to a composite electrolyte membrane having the proton conductivity, which is for use in a fuel cell, water electrolysis, hydrohalic acid electrolysis, salt electrolysis, an oxygen concentrator, a humidity sensor, a gas sensor, and the like, and to a producing method thereof.

2. Description of the Related Art

A fuel cell has high power generation efficiency and excellent capability of restricting a load on the environment. Specifically, the fuel cell is a next-generation energy supply device expected to contribute to solving an environmental problem and an energy problem which are major issues today in countries consuming enormous energy.

Moreover, while the fuel cell is classified by types of electrolytes, a polymer electrolyte fuel cell among them is compact and can obtain high power density. Accordingly, research and development have been advanced on applications of the polymer electrolyte fuel cell to small-scale stationary, mobile body and portable terminal energy supply sources.

For an electrolyte membrane of the polymer electrolyte fuel cell, a solid polymer material is used, which has a hydrophilic functional group such as a sulfonic acid group and a phosphoric acid group in a polymer chain. Such a solid polymer material is strongly bonded to a specific ion, and has property to selectively transmit a cation or an anion therethrough. Accordingly, the solid polymer material is formed into a particulate, fiber or membrane shape, and is utilized for various purposes such as electrodialysis, diffusion dialysis, and a cell diaphragm.

Furthermore, at present, the polymer electrolyte fuel cell is being actively improved as power generation means that can obtain high comprehensive energy efficiency. Main constituents of the polymer electrolyte fuel cell are both electrodes which are an anode and a cathode, a separator forming a gas flow channel, and a solid polymer electrolyte membrane separating both of the electrodes from each other. Protons generated on a catalyst of the anode move through the solid polymer electrolyte membrane, reach a catalyst of the cathode, and react with oxygen. Hence, ion conduction resistance between both of the electrodes largely affects cell performance.

In order to form the fuel cell by using the above-described solid polymer electrolyte membrane, it is necessary to join the catalysts of both of the electrodes and the solid polymer electrolyte membrane to one another by an ion conduction path. For this purpose, in fabricating the fuel cell, a general method has been used, which uses, as each of the electrodes, a catalyst layer formed by mixing a solution of a polymer electrolyte and catalyst particles and contacting both thereof by coating/drying, and presses the catalysts of the electrodes and the solid polymer electrolyte membrane while heating these.

As the polymer electrolyte that is in charge of ion conduction, in general, used is a polymer in which the sulfonic acid group is introduced into a perfluorocarbon principal chain. Specific commercial articles include Nafion made by DuPont Corporation, Flemion made by Asahi Glass Co., Ltd., Aciplex made by Asahi Kasei Corporation, and the like.

A perfluorosulfonic acid polymer electrolyte is composed of the perfluorocarbon principal chain and a side chain having the sulfonic acid group. It is conceived that the polymer electrolyte undergoes micro-phase separation into a region mainly containing the sulfonic acid group and a region mainly containing the perfluorocarbon principal chain, and that a phase of the sulfonic acid group forms clusters. Such a spot where the perfluorocarbon principal chain aggregates contributes to chemical stability of a perfluorosulfonic acid electrolyte membrane, and it is a portion where the sulfonic acid group aggregates to form the clusters that contributes to the ion conduction.

It is difficult to produce the perfluorosulfonic acid electrolyte membrane as described above, which combines excellent chemical stability and ion conductivity, and there is a drawback that the electrolyte membrane concerned becomes extremely expensive. Therefore, application of the perfluorosulfonic acid electrolyte membrane is limited, and it is extremely difficult to apply the electrolyte membrane concerned to the polymer electrolyte fuel cell expected as the power source of the mobile body.

Meanwhile, a current polymer electrolyte fuel cell is operated in a relatively-low temperature range from room temperature to approximately 80° C. Such a limitation on the operation temperature is caused by the following. Specifically, a fluorine membrane for use has a glass transition point at around 120 to 130° C., and in a temperature range higher than the point concerned, it becomes difficult to maintain an ion channel structure contributing to the proton conduction. Therefore, substantially, it is desired to use the polymer electrolyte fuel cell at a temperature of 100° C. or less. In addition, since water is used as a proton-conducting medium, it becomes necessary to pressurize the polymer electrolyte fuel cell concerned when the temperature exceeds 100° C. that is the boiling point of water, and a scale of a fuel cell system becomes large.

However, when the operation temperature is low, the power generation efficiency of the fuel cell becomes low, and poisoning of the catalysts by CO becomes prominent. When the operation temperature is 100° C. or more, the power generation efficiency improves, and in addition, waste heat becomes usable. Accordingly, energy can be efficiently utilized. Moreover, when considering that the fuel cell is to be applied to a fuel cell electric vehicle, if it becomes possible to raise the operation temperature to 120° C., then not only the efficiency is enhanced but also a load on a radiator, which is needed to radiate heat, will be lowered. Then, a radiator that is equivalent in specification to that for use in the current mobile body can be applied, and the system can be made compact.

As described above, in order to realize the operation at the higher temperature, various studies have been conducted heretofore. Typically, as an action also viewing a cost reduction of the above-described electrolyte membrane, it has been studied to apply, in place of the fluorine membrane, an aromatic hydrocarbon polymer material that is inexpensive and excellent in heat resistance to the solid polymer electrolyte. For example, as the solid polymer electrolyte, a variety of hydrocarbon solid polymer electrolytes have been studied, which include sulfonated polyether ether ketone, sulfonated polyether sulfone, sulfonated polyether ether sulfone, sulfonated polysulfide, and polybenzimidazole (refer to Japanese Patent Laid-Open Publication No. H06-93114 (published in 1994), Japanese Patent Laid-Open Publication No. H09-245818 (published in 1997), Japanese Patent Laid-Open Publication No. H11-116679 (published in 1999), Japanese Patent Laid-Open Publication No. H11-67224 (published in 1999), published Japanese translation of a PCT international publication H11-510198 (published in 1999), and Japanese Patent Laid-Open Publication No. H09-110982 (published in 1997). Moreover, it has also been studied to apply a silicon polymer material to the solid polymer electrolyte (refer to Japanese Patent Laid-Open Publication No. 2004-241229).

### SUMMARY OF THE INVENTION

However, the aromatic hydrocarbon polymer is an extremely rigid compound, and has a problem that there is a high possibility to be broken when the electrodes are formed. Moreover, such a hydrocarbon polymer material is modified by the acidic group such as the sulfonic acid group and the phosphoric acid group in order to impart the proton conductivity thereto, and is water-soluble or water-swellable. When the hydrocarbon polymer material is water-soluble, the material concerned cannot be applied to a system such as the fuel cell, where water is generated. Meanwhile, when the hydrocarbon polymer material is water-swellable, there is a possibility that the electrodes are broken owing to a stress caused by swelling. Moreover, though it is desired to increase the acidic group introduced into the electrolyte in order to realize high proton conductivity, it becomes difficult for the polymer material itself to maintain a membrane shape thereof when an introduced amount of the acidic group exceeds a certain threshold value.

Moreover, though exhibiting ion conductivity as high as several 10 mS/cm at the temperature of 100° C. or more, the above-described silicone polymer material has difficulty maintaining sufficient ion conductivity in a low-temperature range from the room temperature to 80° C. since the silicone polymer material concerned uses phosphoric tungstic acid. Moreover, an electrolyte membrane in Japanese Patent Laid-Open Publication No. 2004-241229 uses a general-purpose porous polymer material for a support, and the porous polymer material is said to be a realistic material in consideration of the industrial technical background. However, though having heat resistance of 100° C. or more in terms of material property, the porous polymer material has a high possibility to be broken and so on when a load is continuously applied thereto at high temperature and high humidity.

As described above, to maintain dimensional stability/self-organization as the electrolyte membrane, which can affect reliability of the fuel cell, and to enhance the ion conductivity, which aims an improvement of cell performance, individually relate to the amounts of sulfonic acid group, phosphoric acid, and the like, which are introduced into resin. Both of the above-described properties are in a trade-off relationship, and accordingly, an improvement of one of them deteriorates the other property. Therefore, it has been difficult to realize an electrolyte membrane that combines both of the properties.

The present invention has been created in consideration of the problems as described above, which are inherent in the conventional technology. It is an object of the present invention to provide a proton-conductive composite electrolyte membrane that has excellent ion conductivity, high heat resistance, and restricted swelling when being hydrous, and is capable of being produced at low cost, and to provide a producing method thereof.

The first aspect of the present invention provides a composite electrolyte membrane comprising: a porous body composed of an inorganic substance, the porous body including therein plural spherical pores in which a diameter is substantially equal, and communicating ports each allowing the spherical pores adjacent to each other to communicate with each other; and an electrolyte material provided on the spherical pores and the communicating ports, having proton conductivity, and composed of a hydrocarbon polymer.

The second aspect of the present invention provides a method of producing a composite electrolyte membrane comprising: mixing and agitating a sol composed of an inorganic substance, a spherical organic resin and a solvent; filtering a mixed liquid comprising the sol, the organic resin and the solvent to fabricate a membrane comprising the sol and the organic resin; removing an extra solvent contained in the membrane; drying the membrane from which the extra solvent is removed; firing the dried membrane to form a porous body; impregnating the porous body with an electrolyte material comprising a hydrocarbon polymer; and drying the porous body impregnated with the electrolyte material.

### BRIEF DESCRIPTION OF THE DRAWINGS

The invention will now be described with reference to the accompanying drawings wherein;

FIG. 1A is a schematic view showing a cross section of an electrolyte membrane of a first embodiment;

FIG. 1B is a photograph showing a porous body constituting the electrolyte membrane of the first embodiment;

FIG. 2 is structural formulae showing examples of polyether polymers;

FIG. 3 is a flowchart showing a fabrication procedure of the electrolyte membrane of the first embodiment;

FIG. 4 is a photograph showing the cross section of the electrolyte membrane of the first embodiment;

FIG. 5 is a graph showing a measurement example of an energy dispersive X-ray spectroscopy (EDS) spectrum;

FIG. 6 is a graph showing proton conductivities obtained in Example 1 and Comparative example 1;

FIG. 7 is a schematic view showing a cross section of an electrolyte membrane of a second embodiment;

FIG. 8 is a graph showing a relationship between a diameter of spherical pores and an amount of a functional group;

FIG. 9 is a graph showing the diameter of the spherical pores and an equivalent weight (EW) value;

FIG. 10 is a flowchart showing a fabrication procedure of the electrolyte membrane of the second embodiment;

FIGS. 11A and 11B are flowcharts showing a procedure of fixing a proton-conductive functional group on inner walls of the spherical pores;

FIG. 12 shows infrared spectra for confirming a reduction of a silanol group; and

FIG. 13 is a graph showing proton conductivities obtained in Examples 2 and 3 and Comparative examples 2 and 3.

### DETAILED DESCRIPTION OF THE PREFERRED EMBODIMENT

Hereinafter, description will be made of embodiments of the present invention with reference to the drawings.

### First Embodiment

A composite electrolyte membrane of the present invention is composed by arranging a hydrocarbon electrolyte material into plural spherical pores owned by a porous body composed of an inorganic material.

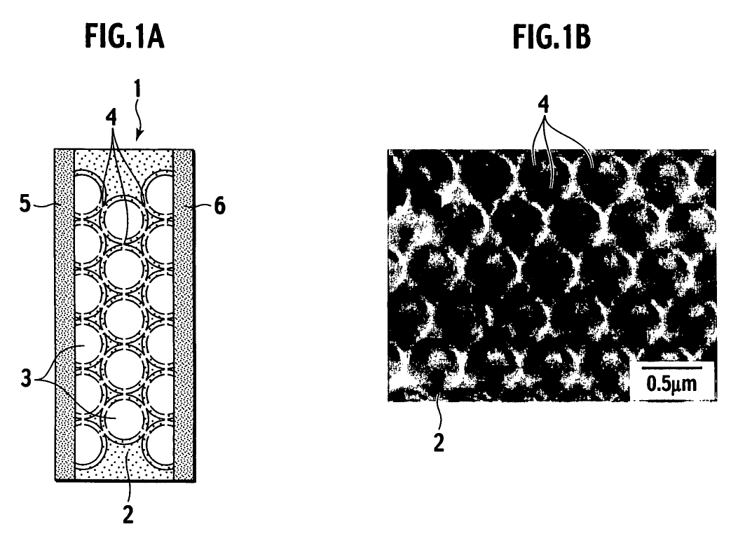

Specifically, as shown in FIG. 1A and FIG. 1B, a porous body 2 constituting an electrolyte membrane 1 of the present invention is composed of an inorganic material, and includes plural spherical pores 3 therein. Moreover, the spherical pores 3 have a substantially equal diameter, and exist three-dimensionally in the porous body 2. Furthermore, the spherical pores 3 adjacent to each other communicate with each other by a communicating port 4. An electrolyte material performing proton conduction is filled in the spherical pores 3 and the communicating ports 4. In constituting a polymer electrolyte fuel cell, an anode 5 and a cathode 6 are arranged on side faces of the electrolyte membrane 1 of the present invention.

As described above, the porous body 2 composed of the inorganic material can be used as a support body of the electrolyte material, and in the inside thereof, the electrolyte material such as an aromatic hydrocarbon polymer excellent in heat resistance can be disposed. Accordingly, an electrolyte membrane excellent in heat resistance is obtained. Moreover, in a wet state, the porous body 2 restricts swelling of the electrolyte material. In particular, since the spherical pores 3 existing in the porous body 2 are composed with the substantially equal diameter, when the electrolyte material swells at the time of being hydrous, the porous body 2 receives uniform and dispersed swelling force, and accordingly, a local breakage of the electrolyte is restricted. In other words, the spherical pores 3 of the porous body 2 exist three-dimensionally and adopt a regular array structure, and accordingly, swelling pressure of the electrolyte material is uniformly applied to the porous body 2. Therefore, the porous body 2 including the spherical pores 3 as described above is suitable for the support body of the electrolyte membrane 1 swelling by being hydrous. Moreover, the diameter of the spherical pores 3 of the porous body 2 is controlled to be substantially equal, thus making it possible to easily introduce the electrolyte material into the spherical pores by impregnation.

Here, it is preferable that the porous body 2 be composed of a material that forms sol (inorganic sol) composed of an inorganic substance. In this case, the sol-gel method that is a simple technology for forming an inorganic material can be applied, and the porous body composed of the inorganic material can be obtained at low cost. Moreover, it is preferable that the material that forms the inorganic sol be colloid (inorganic colloid) composed of the inorganic substance. By adopting the inorganic colloid, the inorganic porous body including the regular pores can be formed.

Moreover, it is preferable that the inorganic porous body contain, for example, silica, titania, zirconia, or tantalum oxide, and an arbitrary combination of these. In this case, inorganic colloid that reaches practical levels can be obtained.

As described later, the inorganic porous body is obtained from a suspension formed by mixing polymer particles and the inorganic material. By applying the suspension, a mold having the three-dimensionally regular array is formed in such a manner that the polymer particles are stacked on one another. Accordingly, the inorganic porous body as shown in FIG. 1A can be obtained. In particular, by controlling a diameter of the polymer particles and a stacked state thereof, an inorganic porous body having an arbitrary pore diameter can be designed. Note that, by removing the polymer particles in the pores by means of a heat treatment and the like, a space into which the electrolyte material enters is ensured.

The inorganic porous body including the spherical pores regularly arrayed, which is as described above, can ensure a high porosity exceeding 70%. Accordingly, the inorganic porous body can introduce a large amount of the electrolyte material into the porous body, and can realize excellent ion conductivity.

As the electrolyte material introduced into the porous body, it is preferable to use one composed by imparting a functional group that expresses proton conductivity to the aromatic hydrocarbon polymer. By applying the aromatic hydrocarbon polymer excellent in heat resistance, the electrolyte membrane excellent in heat resistance can be obtained, and cost thereof can be made lower than the conventional fluorine electrolyte material.

Moreover, it is preferable that the hydrocarbon electrolyte material has an ion-exchange capacity of at least 1 to 6 meq/g. Here, the ion-exchange capacity is an amount of an ion exchange group (meq/g) per 1 g of the electrolyte on the weight basis. In order to set the ion-exchange capacity in the above-described range, a type of the aromatic hydrocarbon electrolyte and the amount of proton-conductive functional group imparted thereto need to be adjusted appropriately. In this case, when the amount of proton-conductive functional group introduced into the electrolyte is less than 1 meq/g, the functional group cannot express sufficient proton conductivity, and when the amount exceeds 6 meq/g, it becomes difficult for the electrolyte material to maintain a solid state.

Note that the conventional fluorine electrolyte membrane represented by Nafion (DuPont Corporation) has an ion-exchange capacity of approximately 1 meq/g. It is difficult for the conventional membrane concerned to achieve an ion-exchange capacity of 2 meq/g or more. On the other hand, in the present invention, it is possible to design an electrolyte membrane having higher proton conductivity than the conventional one.

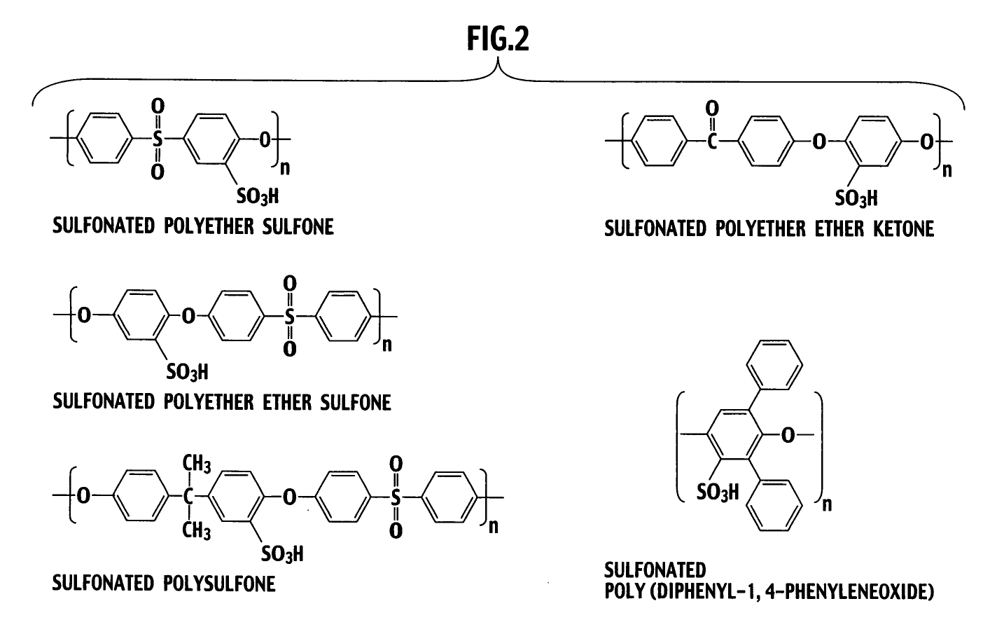

Moreover, as the hydrocarbon electrolyte material, it is preferable to use polyether. Specifically, as shown in FIG. 2, polyether ether ketone, polyether sulfone, and the like, which are obtained by sulfonating polyether substances, can be used. Moreover, sulfonated polyether ether sulfone, sulfonated polysulfone, and sulfonated poly(diphenyl-1,4-phenyleneoxide) can also be used. In particular, it is recommended to use the polyether ether sulfone. When the materials as described above are used, a large amount of the electrolyte material can be impregnated into the inorganic porous body having the space where the spherical pores are regularly arrayed, thus making it possible to obtain the electrolyte more excellent in proton conductivity than the conventional article.

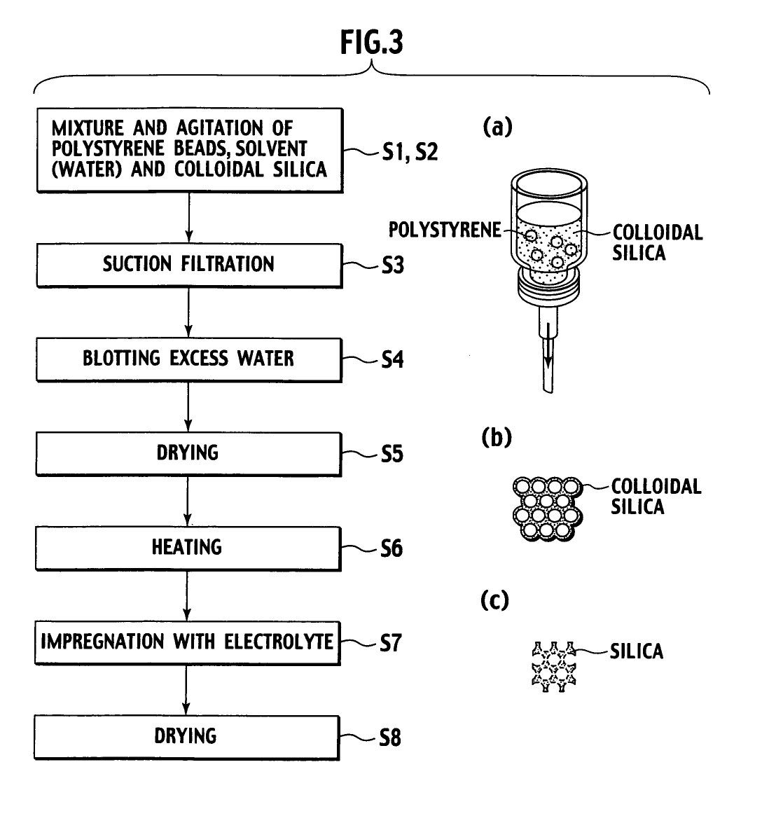

Next, a producing method of the proton-conductive composite electrolyte membrane of this embodiment is described in detail. A flow of a fabricating procedure is shown in FIG. 3. In the producing method of the present invention, the following steps are performed, and the above-described composite electrolyte membrane is produced.

1. Step S1 of mixing an inorganic sol and a spherical organic resin in the solvent

2. Step S2 of agitating the mixed liquid thus obtained, and obtaining the suspension

3. Step S3 of filtering the suspension to fabricate the membrane composed of the sol and the organic resin

4. Step S4 of removing (blotting) extra moisture contained in the membrane formed by the filtering

5. Step S5 of drying the membrane from which the extra moisture is blotted

6. Step S6 of firing the membrane, which is thus dried, to form the porous body

7. Step S7 of impregnating the inorganic porous body obtained by the firing with the hydrocarbon electrolyte material

8. Step S8 of drying the inorganic/organic composite electrolyte membrane impregnated with the electrolyte material

In Step S1 and Step S2, the inorganic colloid and the organic resin material are agitated and mixed into a uniform state, thus the inorganic porous body including the regular spherical pores can be obtained. As the inorganic colloid, one composed of silica, titania, zirconia, tantalum oxide, or the like can be used. Moreover, as the organic resin material, any one can be used as long as it is extinguished by the firing Step S6 and forms the spherical pores.

In Step S3, the filtering is suitable as a method of filling the inorganic sol into gaps of the organic resin template. As shown in FIG. 3(a), with regard to the filtering, it is facilitated to collect a membrane generated on filter paper by using a separating funnel. Furthermore, in Step S4, a solvent contained in the membrane formed by the filtering is removed in advance, thus a drying time in the subsequent drying step can be shortened. By removing the solvent, as shown in FIG. 3(b), polystyrene beads are arrayed regularly, and further, the inorganic sol is filled in the gaps of the beads concerned.

In Step S5, the above-described membrane is dried in advance at room temperature, thus facilitating handling of the membrane in the firing step and so on. Subsequently, in Step S6, by firing the membrane, the inorganic support made of the inorganic sol is formed, and the organic resin is removed by the firing, thus the inorganic porous body can be formed (refer to FIG. 3(c)).

In Step S7 and Step S8, the obtained porous body is impregnated with the electrolyte material, and is further dried, thus the target inorganic/organic composite electrolyte membrane can be obtained. In particular, temperature to an extent where the polymer electrolyte is not broken is given to the membrane concerned at the time of drying, thus the drying time can be shortened. In addition, in the case of concurrently using a crosslinking agent at the time of impregnating the polymer electrolyte, a crosslinking reaction thereof is promoted, and a more rigid membrane can be obtained.

By being subjected to the above-described Steps S1 to S6, the inorganic porous body in which the pores are regularly arrayed three-dimensionally while using the organic resin material as the template is obtained. In particular, the filtering Step S3 is suitable as a method of favorably filling the inorganic colloid while using the spherical organic resin as the template. As the spherical organic resin, polyolefin resin which are represented by polyethylene, polystyrene resin, crosslinked acrylic resin, methylmethacrylate resin, polyamide resin and the like can be appropriately selected. Further, it is preferable that a diameter of the spherical organic resin range from 20 nm to 1500 nm. When the diameter gets smaller than 20 nm, it tends to become difficult to uniformly impregnate the electrolyte polymer. Meanwhile, when the diameter gets larger than 1500 nm, a disturbance sometimes occurs in uniformity of the support structure constituting the inorganic porous body.

Moreover, the filtering can be performed while reducing pressure by 10 to 60 kPa in consideration of a size and porous density of the spherical pores of the inorganic porous body.

Furthermore, in Step S6, it is recommended that temporal firing for removing the organic resin material in the membrane be performed, followed by production firing of the inorganic porous body. For the temporal firing, a heat treatment is performed for 30 minutes or more while raising the temperature to 400 to 500° C., preferably to 430 to 470° C., at a temperature rise rate of 1 to 10° C./min, preferably 2 to 5° C./min. For the production firing, for example, a heat treatment can be performed for a range of 30 to 100 minutes at 800 to 900° C. or more. The production firing may be repeated plural times.

Moreover, in Step S7, the impregnated electrolyte material may take any shape of powder, beads, gel, and solution as long as it can be served for the impregnation step. Moreover, the impregnated solution can be appropriately selected for use from water, alcohols having linear and branched chains, which are represented by methanol, ethanol, n-propanol, isopropanol, and the like, olefins such as n-hexane and cyclohexane, an aromatic solvent represented by toluene, and xylene, ethers represented by dimethyl ether and the like, ethyl acetate, methyl acetate, acetonitrile, dimethyl sulfoxide (DMSO), dichloroethane (EDC), dioxane, tetrahydrofuran (THF), dimethylformamide (DMF), n-methylpyrrolidone (NMP), and the like. Furthermore, when being used, the above-described solvents may be used either singly or by appropriately selecting and mixing a plurality thereof.

This embodiment is described below further in detail by an example and a comparative example. However, this embodiment is not limited to these examples.

### EXAMPLE 1

A silica porous membrane was used as a matrix, the proton-conductive polymer was introduced into pores thereof, and the inorganic/organic composite electrolyte membrane was thus fabricated.

1) Fabrication of Inorganic Porous Body

As the organic resin material for controlling the pore diameter of the inorganic porous body, polystyrene spherical particles with a mean diameter of approximately 500 nm was used. The polystyrene spherical particles and colloidal silica with a diameter of 70 to 100 nm were mixed and prepared so that the porous body could have a predetermined film thickness when being formed with regard to a volume of a solute contained in the suspension. As for the procedure, first, a predetermined amount of polystyrene was weighed, and added to water. Thereafter, a solution containing the colloidal silica was added to a liquid containing the polystyrene particles. Then, ultrasonic agitation was performed for the liquid thus obtained, and the suspension in which the particles were uniformly dispersed was obtained.

Subsequently, the suspension was filtered. A membrane filter was set on a filter holder, and pressure therein was reduced by using a manual vacuum pump so that a pressure difference from the atmospheric pressure could not exceed 10 kPa, and the suspension was filtered. After the suspension was filtered entirely, the extra solvent contained in the membrane formed by the filtering was removed by using the filter paper as an absorbent material, and the suspension was sufficiently dried at the room temperature, followed by peeling from the membrane filter. In such a way, the membrane composed of a mixture of the polystyrene and silica was obtained.

The mixture membrane thus obtained was subjected to a heat treatment in the following manner. First, in order to remove the polystyrene, the temperature was raised to 450° C. at a temperature rise rate of 3° C./min, and the temporary firing was performed for 60 minutes at the raised temperature. Moreover, in order to sinter silica, a heat treatment was performed for about 60 minutes at 800° C. or more after the temporal firing. Furthermore, in order to enhance mechanical strength of the membrane concerned, a heat treatment was performed for 15 minutes at a temperature of 900° C. or more, and the temperature was returned to the room temperature slowly. In such a way, the target inorganic porous body was obtained.

2) Impregnation of Polymer Electrolyte Material

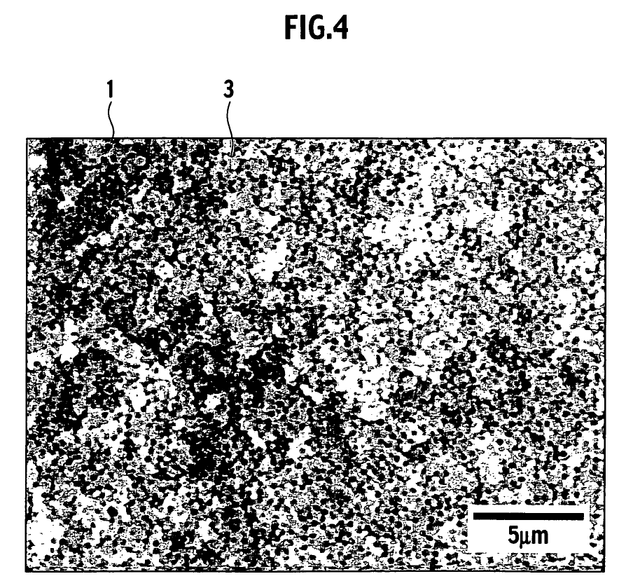

By sulfonating a commercially available polymer, the polyether electrolyte material was fabricated. Poly(oxy-1,4-phenyleneoxy-1,4-phenylenesulfony1-1,4-phenylene) was used as a starting substance, and a polymer electrolyte material obtained by sulfonating the substance concerned was used. The polymer thus obtained was dissolved into the solvent, an obtained polymer solution was introduced into the pores, and the composite electrolyte membrane was thus fabricated. Specifically, an electrolyte aqueous solution adjusted to a predetermined concentration was impregnated into the silica porous membrane, water was evaporated, and the composite electrolyte membrane was thus fabricated. An SEM image of a cross section of the obtained inorganic/organic composite electrolyte membrane is shown in FIG. 4. From the image, it was observed that the electrolyte resin existed on the surface of the inorganic porous body.

Moreover, by neutralization titration, an amount of sulfonic acid group per unit weight of the dried aromatic hydrocarbon polymer was obtained, and the ion-exchange capacity of the obtained electrolyte material was calculated. The ion-exchange capacity of the electrolyte material of this example was 3.2 meq/g. This value of the ion-exchange capacity was three times or more that of Nafion as a representative fluorine electrolyte membrane at present. The obtained electrolyte material had a high concentration of the sulfonic acid group, and worked more advantageously for expressing the proton conductivity.

### COMPARATIVE EXAMPLE 1

Similar operations to those of Example 1 were performed except that a Nafion solution was used as the polymer electrolyte material impregnated into the inorganic porous body, and a composite electrolyte membrane was fabricated. For the impregnation, a 20% solution of Nafion was used, and the Nafion solution was impregnated into the surface of the silica porous membrane fabricated in a similar way to Example 1, followed by evaporation of the solvent in a dryer, and a Nafion-impregnated membrane was thus obtained.

### (Evaluation)

1) Determination of Ion-Conductive Functional Group Introduced Into Inorganic/Organic Composite Electrolyte Membrane

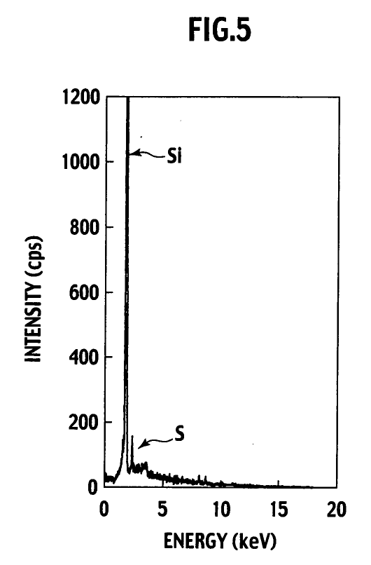

For the inorganic/organic composite electrolyte membrane obtained in Example 1, the introduced amount of functional group in charge of the proton conduction, which was bonded to the polymer electrolyte impregnated into the electrolyte membrane, was measured by the energy dispersive X-ray spectroscopy method (EDS method). The EDS method can measure characteristic X-rays emitted from a sample, and can analyze composition elements of the sample. Results of the analysis are shown in FIG. 5.

As shown in FIG. 5, a silicon element (Si) constituting the inorganic porous body and a sulfur element (S) derived from the sulfonic acid group introduced into the polymer electrolyte were detected by an EDS spectrum. From detected peaks in the spectrum, amounts of the individual elements were obtained by sensitivity adjustment, and an element ratio S/Si was obtained. The electrolyte membrane of Example 1 expressed 15.9 as a value of the element ratio S/Si, and it was found that a sufficient amount of the electrolyte existed therein. Meanwhile, in the Nafion-impregnated membrane obtained in Comparative example 1, the element ratio S/Si was less than 0.1 (refer to Table 1). As described above, in the electrolyte membrane of the present invention, more. electrolyte was introduced into the inorganic porous body than in the Nafion-impregnated membrane.

At the present time, a mechanism of the above is not clear. However, as a result of a scattering measurement of X-rays and neutrons by Gebel, it is reported that, in Nafion in a solution state, the sulfonic acid group surrounds a network composed of a polymer, and water surrounds a stick-like body thus formed (refer to G. Gebel, Polymer, 41, 5829-5838 (2000)). From the above, it can be assumed that such a polymer micelle composed in a stick shape inhibits the introduction of Nafion into pores of the inorganic porous body in which electron holes are controlled in a nanometer order.

TABLE 1

| | | Proton conductivity |
|---|---|---|
| | S/Si | at 30° C. (S/cm) |
| Example 1 | 15.9 | 1.3 × 10⁻² |
| Comparative Example 1 | <0.1 | 5.7 × 10⁻⁴ |

2) Evaluation of Proton Conductivity of Inorganic/Organic Composite Electrolyte Membrane

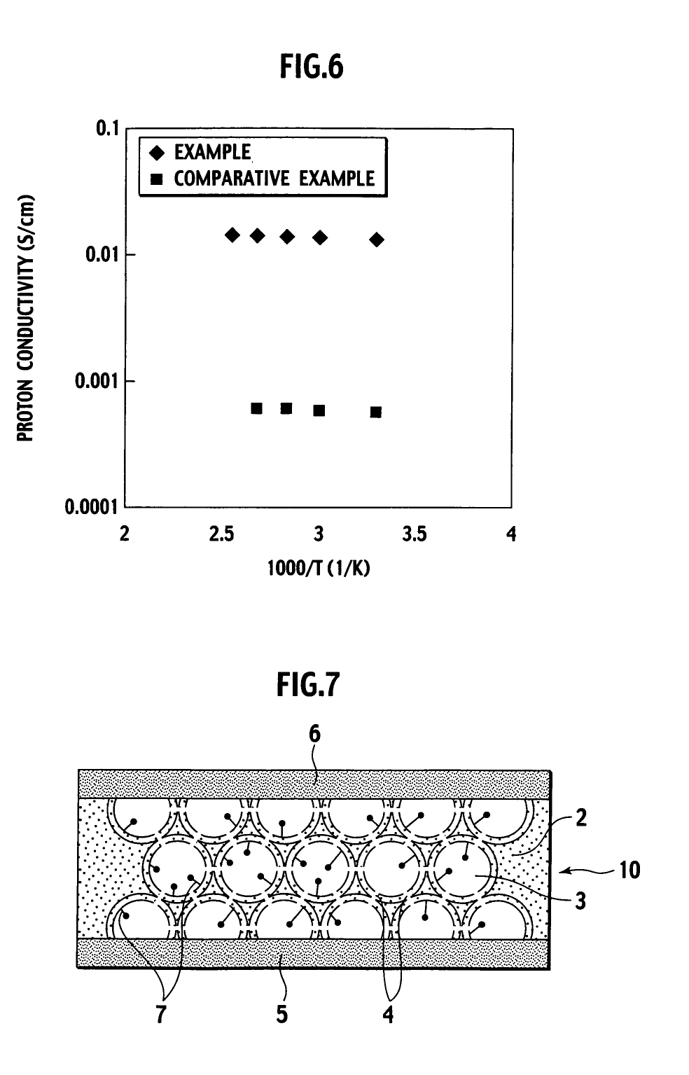

With regard to the proton conductivity of the obtained composite electrolyte membrane, evaluation thereof was performed by impedance measured in such a manner that the sample was sandwiched by metal electrodes with a predetermined area from both surfaces thereof, and that an alternating voltage wave with a frequency of 100 Hz to 1 MHz was applied to the sample. The ion conductivity here was calculated based on an area of the sample in contact with the metal electrodes without considering the porosity. The measurement was performed while adjusting temperature/humidity environments so that a vapor partial pressure could be in a saturated state. Results of the measurement are shown in FIG. 6 and Table 1.

As shown in FIG. 6, the electrolyte membrane obtained in Example 1 exhibited higher ion conductivity than the Nafion-impregnated membrane. Moreover, though it was obviously and visually confirmed that a dimensional change occurred in the Nafion-impregnated membrane, such a dimensional change was not visually observed in the electrolyte membrane obtained in Example 1 even if the environmental humidity was changed, and an effect was observed for the swelling of the electrolyte, which was accompanied with being hydrous.

### Second Embodiment

Description is made below of a proton-conductive composite electrolyte membrane of a second embodiment. The same reference numerals are assigned to constituents described in the following specification with reference to the drawings, which have the same functions as those described in the first embodiment, and duplicate description thereof is omitted.

In the proton-conductive composite electrolyte membrane of this embodiment, a proton-conductive functional group is provided on an interface between the inorganic porous body and the hydrocarbon electrolyte in the composite electrolyte membrane of the first embodiment. Specifically, as shown in FIG. 7, an inorganic porous body 2 constituting a composite electrolyte membrane 10 includes the plural spherical pores 3 as described above; however, in this embodiment, a proton-conductive functional group 7 is provided on the surfaces of the spherical pores 3. Since the hydrocarbon electrolyte is filled in the spherical pores 3, the functional group 7 will exist on the interface between the inorganic porous body 2 and the electrolyte. The functional group 7 as described above is provided on the surfaces of the spherical pores 3, and the proton conductivity is thus enhanced more than in the electrolyte membrane of the above-described first embodiment.

The same porous body as the first embodiment can be used as the inorganic porous body in the electrolyte membrane of this embodiment. Preferably, a diameter of the spherical pores 3 of the inorganic porous body 2 is within a range from 20 to 200 nm in consideration of a balance between an amount of the proton-conductive functional group 7 and difficulty introducing the hydrocarbon electrolyte. In this case, the ion conductivity of the electrolyte membrane can be enhanced. When the diameter exceeds 200 nm, the amount of functional group per unit weight of the inorganic porous body is small, and accordingly, the proton conductivity cannot be enhanced sufficiently. When the diameter is less than 20 nm, it tends to become difficult to form the porous body by using the spherical resin as the template. More preferably, the diameter of such spherical pores 3 is within a range from 50 to 150 nm. In this case, the proton-conductive functional group can contribute sufficiently to the ion conduction by surface modification. Specifically, when the diameter becomes 150 nm or less, the amount of functional group per unit weight of the inorganic porous body is radically increased, and the functional group can exert a sufficient effect. When the diameter becomes 50 nm or more, it becomes easier to form the porous body by using the spherical resin as the template, and the electrolyte membrane can be produced stably.

A functional group having a function as a Brønsted acid (i.e. a proton donor) can be employed as the proton-conductive functional group 7 present on surfaces of the spherical pores 3. In this case, a region that promotes the proton conduction is formed on the interface between the porous body and the electrolyte and in the organic electrolyte. Accordingly, the proton conductivity can be enhanced more than in the electrolyte membrane of the first embodiment. Specifically, the sulfonic acid group, the phosphoric acid group, or a carboxylic acid group, and an arbitrary combination thereof can be introduced as the functional group 7.

The amount of introducible proton-conductive functional group 7 differs depending on the diameter of the spherical pores. However, in terms of enhancing the proton conductivity, it is preferable that the proton-conductive functional group be contained in a ratio of 0.2 to 2.8 mmol/g per unit weight of the inorganic porous body. It is more preferable that the proton-conductive functional group be contained in a ratio of 0.3 to 1.2 mmol/g per unit weight of the inorganic porous body. For example, a concentration of the proton-conductive functional group is set substantially equal to or more than a concentration (approximately 0.9 to 1.1 mmol/g) of the proton-conductive functional group existing in the Nafion membrane used for the polymer electrolyte fuel cell (PEFC) in general, thus making it possible to expect an effect to express higher proton conductivity.

Moreover, from a similar viewpoint, preferably, an equivalent weight (EW) value of the inorganic porous body is within a range from 350 to 3600 g/eq, more preferably, 890 to 2700 g/eq. Note that, usually, the EW value is defined as weight of a dried polymer per equivalent weight of the sulfonic acid group in the electrolyte membrane represented by Nafion. However, the inorganic porous body including the proton-conductive functional group is taken here as a subject, and the EW value represents weight of the dried inorganic porous body per equivalent weight of the proton-conductive functional group. When the EW value is within the above-described range, an effect can be expected to enhance the proton conductivity by the introduction of the functional group.

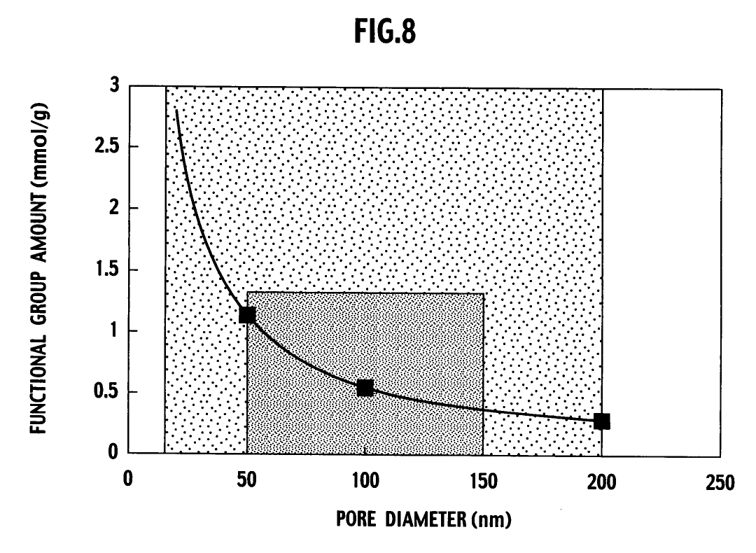

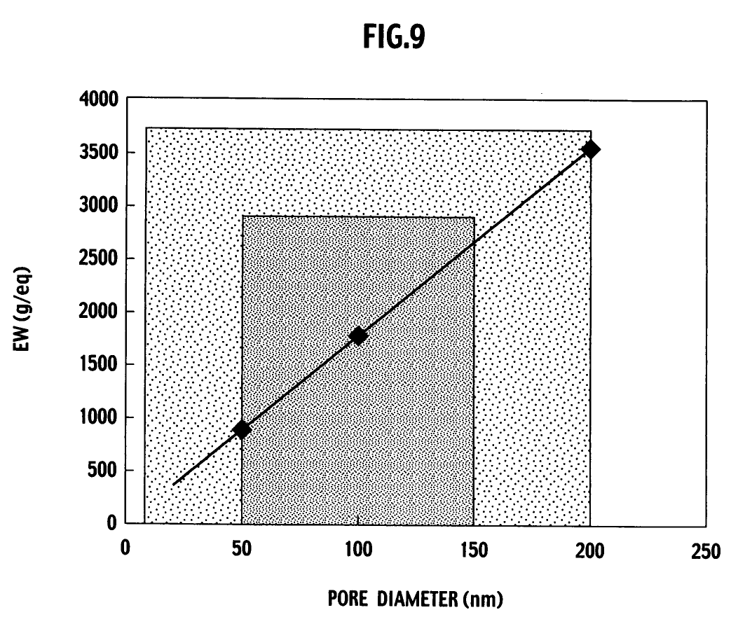

Moreover, also by increasing a surface area of the spherical pores per unit membrane weight, the amount of proton-conductive functional group contained in the composite electrolyte membrane can be increased. Specifically, when a relationship between the pore diameter of the porous body and the amount of introducible functional group, and a relationship between the pore diameter of the porous body and the EW value, are calculated based on the monovalent proton-conductive functional group introducible per unit surface area of the metal oxide, results thereof become as shown in FIG. 8 and FIG. 9, respectively. As described above, it is found that the amount of functional group introducible into the inorganic porous body gets larger as the pore diameter gets smaller. Moreover, focusing on the EW, it is desirable that the EW value gets small since the EW value represents unit weight of the porous body per functional group. From FIG. 9, it is found that the EW value gets smaller as the pore diameter gets smaller.

As in the above-described first embodiment, as the hydrocarbon electrolyte arranged in the spherical pores of the inorganic porous body, it is preferable to use one composed by imparting the functional group expressing the proton conductivity to the hydrocarbon resin. By employing the hydrocarbon resin excellent in heat resistance, the electrolyte membrane excellent in heat resistance can be obtained, and a more inexpensive material than the conventional fluorine electrolyte material can be applied.

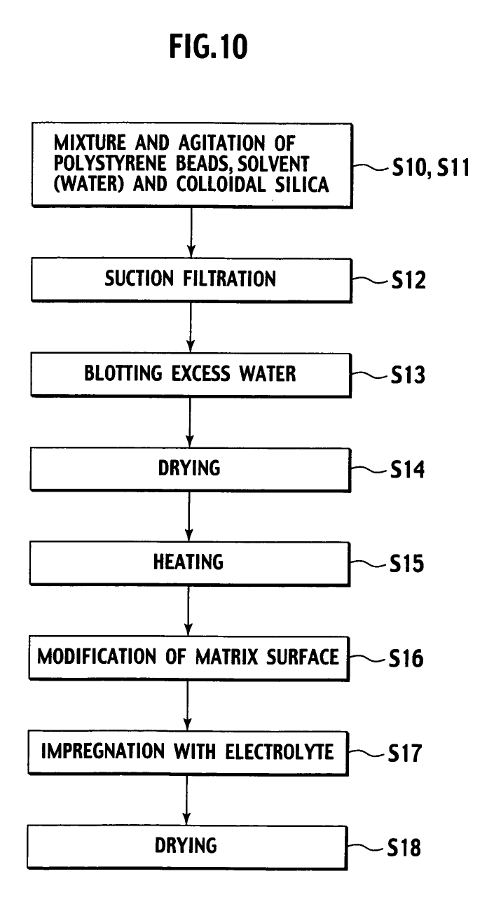

Next, description is made in detail of a producing method of the proton-conductive composite electrolyte membrane of this embodiment. A flow of a fabricating procedure is shown in FIG. 10. In the producing method of the present invention, the following steps are performed, and the above-described composite electrolyte membrane is produced.

1. Step S10 of mixing the inorganic sol and the spherical organic resin in the solvent

2. Step S11 of agitating the mixed liquid thus obtained, and obtaining the suspension

3. Step S12 of filtering the suspension to fabricate the membrane composed of the sol and the organic resin

4. Step S13 of removing (blotting) extra moisture contained in the membrane formed by the filtering

5. Step S14 of drying the membrane from which the extra moisture is blotted

6. Step S15 of firing the membrane, which is thus dried, to form the porous body

7. Step S16 of introducing the proton-conductive functional group onto the surfaces of the spherical pores of the inorganic porous body obtained by the firing

8. Step S17 of impregnating the inorganic porous body with the hydrocarbon electrolyte material

9. Step S18 of drying the inorganic/organic composite electrolyte membrane impregnated with the electrolyte material

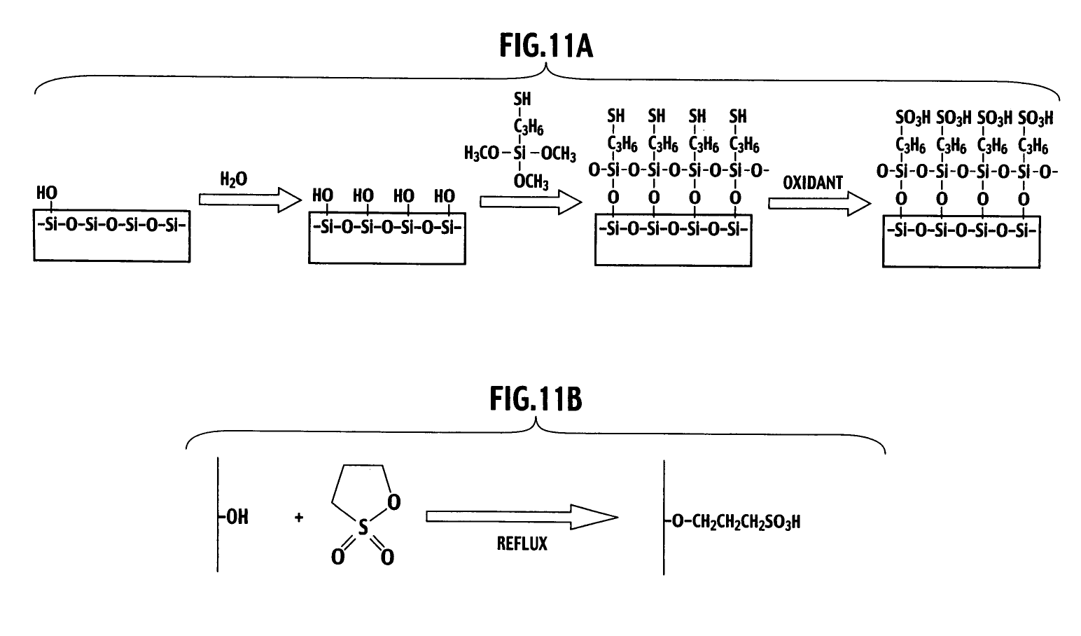

The above-described Steps S10 to S15 can be performed in a similar way to Steps S1 to S6 of the first embodiment. As shown in FIG. 11A, in Step S16, a silanol group on the surfaces of the spherical pores of the silica porous body is first increased by a hydrothermal treatment. The hydrothermal treatment is performed by heating the inorganic porous body together with water while being pressurized. Then, the silica porous body in which the silanol group is increased is immersed in a 2 to 3.5% solution of a silane coupling agent for 30 minutes to 24 hours, and a mercapto group (SH group) was thus formed. Thereafter, the mercapto group can be oxidized to form the sulfonic acid group (SO₃H group). Note that, as another method, the above-described porous body subjected to the hydrothermal treatment can be impregnated into a toluene solution of 1,3-propanesultone and flown back at 120° C. for 24 hours to introduce the sulfonic acid group by a single-step reaction. Here, the toluene solution is adjusted to 5% concentration. The above-described Steps S17 and S18 can be performed in a similar way to Steps S7 and S8 of the first embodiment.

This embodiment is described below further in detail by examples and comparative examples; however, this embodiment is not limited to these examples.

### EXAMPLE 2

A silica porous membrane was used as a matrix, the proton-conductive polymer was introduced into pores thereof, and the proton-conductive composite electrolyte membrane was thus fabricated.

1) Fabrication of Silica Porous Body

The silica porous body was obtained by the steps described in “1) Fabrication of inorganic porous body” of Example 1 except that polystyrene spherical particles with a mean diameter of approximately 200 nm were used as the organic resin material for controlling the pore diameter of the silica porous body.

2) Modification of Spherical Pore Inner Wall of Porous Body

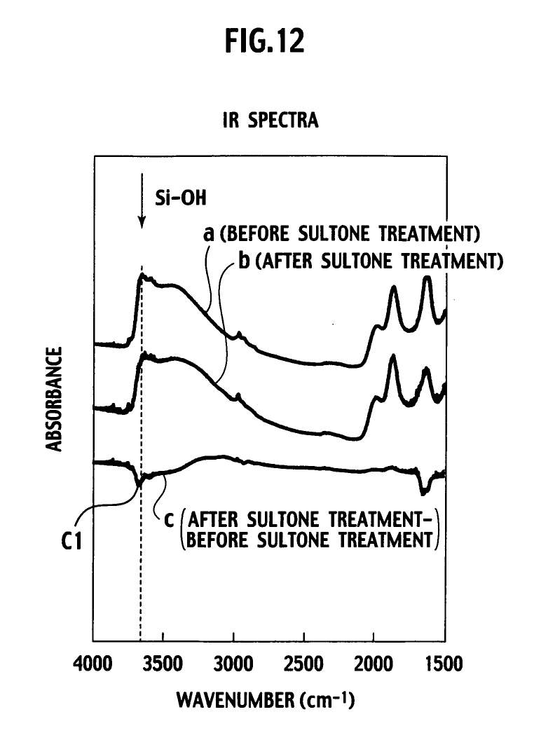

The spherical pore inner walls of the porous body were modified by the method shown in FIG. 11A. First, the obtained silica porous body was put into water, and was heated at 170° C. for 24 hours by using an autoclave. The introduced silanol group (SiOH group) was measured and confirmed by using a Fourier transform infrared spectrophotometer (FT-IR). Specifically, as shown in FIG. 12, peaks derived from the SiOH group, which were seen in a wavenumber range of about 3500 to 3700 cm⁻¹, were detected, and the introduction of the SiOH group was confirmed.

Next, the mercapto group (SH group) was introduced into the spherical pores of the silica porous body. The silica porous body was immersed in a 2.6% solution of γ-Mercaptopropyltrimethoxysilane for 20 hours. Thereafter, the silica porous body was dried in vacuum at 100° C. for 10 minutes. Absorption of the mercapto group onto the spherical pore walls was observed by the FT-IR. In FIG. 12, a segment a shows an IR spectrum of the surface of the porous body before the reaction with γ-Mercaptopropyltrimethoxysilane, a segment b shows an IR spectrum of the surface of the porous body after the reaction, and a segment c shows a difference obtained by subtracting the IR spectrum before the reaction from the IR spectrum after the reaction. From c1 of FIG. 12, it was observed that absorbance at the peak derived from the SiOH group was reduced, and therefore, it was found that the SiOH group was reduced, and that a reaction of the SiOH group and the silane was advanced instead thereof.

Thereafter, the porous body was reacted with a 10% solution of hydrogen peroxide at 70° C. for 2 hours, and the sulfonic acid group formed by oxidizing the mercapto group was thus obtained. The existence of the sulfonic acid group on the spherical pore inner walls was observed by electron spectroscopy for chemical analysis (ESCA), and was confirmed.

3) Impregnation of Polymer Electrolyte Material

The polymer material was introduced into the spherical pores by the steps described in “2) Impregnation of polymer electrolyte material” of the above-described Example 1. The same material as in Example 1 was used as the electrolyte material introduced into the spherical pores.

The ion-exchange capacity of the composite electrolyte membrane of this example was 3.2 meq/g. This value of the ion-exchange capacity was three times or more that of Nafion as a representative fluorine electrolyte membrane at present.

### EXAMPLE 3

Similar operations to those of Example 2 were performed except that polymer gel (AMPS gel) was used, which was obtained by polymerizing 2-acrylamido-2-methylpropanesulfonic acid, N,N′-methyl-bisacrylamide (crosslinking agent), and ammonium peroxide sulfate (initiator). In such a way, the inorganic/organic composite membrane was obtained.

Specifically, a mixed solution obtained by dissolving the above-described material into pure water was dropped onto the silica porous body, vacuum degassing was performed therefor, and the mixed solution was thus filled in the spherical pores of the silica porous body. Subsequently, heat polymerization was performed at 60° C. for 1 hour, and the inorganic/organic composite electrolyte membrane into which the gel electrolyte was introduced was obtained.

### COMPARATIVE EXAMPLES 2 AND 3

Similar operations to those of Examples 2 and 3 were performed except that the spherical pore inner walls of the silica porous body were not modified with the sulfonic acid group, and electrolyte membranes of Comparative examples 2 and 3 were obtained.

### (Evaluation)

1) Determination of Proton-Conductive Functional Group Introduced Into Composite Electrolyte Membrane

Element ratios S/Si were obtained by a similar method to that of Example 1. The element ratios were varied depending on measured spots, and values thereof became 5 to 16. From the above, it was confirmed that the resin was introduced into the inorganic/organic composite electrolyte membrane.

2) Evaluation of Proton Conductivity of Composite Electrolyte Membrane

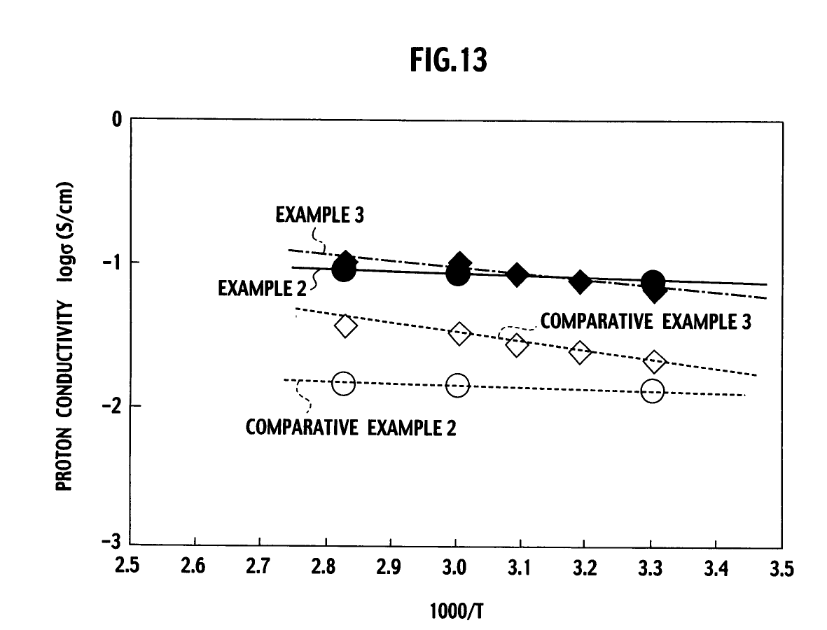

The proton conductivity was evaluated by a similar method to that of Example 1. The ion conductivity here was calculated based on an area of the sample in contact with the metal electrodes without considering the porosity. The measurement was performed while adjusting temperature/humidity environments so that a vapor partial pressure could be in a saturated state. Results of the measurement are shown in FIG. 13.

As shown in FIG. 13, in the electrolyte membranes obtained in Examples 2 and 3, it was observed that the proton conductivities were enhanced as compared with the surface-unmodified membranes of Comparative examples 2 and 3, and the effect of the sulfonic acid group introduced onto the spherical pore inner walls was observed.

The entire contents of Japanese Patent Applications No. P2004-305631 with a filing date of Oct. 20, 2004 and No. P2005-050269 with a filing date of Feb. 25, 2005 are herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A composite electrolyte membrane, comprising:
a porous body composed of an inorganic substance, the porous body including therein plural spherical pores in which a diameter is substantially equal, wherein the diameter of the spherical pore ranges from 20 to 1,500 nm, and communicating ports each allowing the spherical pores adjacent to each other to communicate with each other; and
an electrolyte material comprising polyether, the electrolyte material being filled in the spherical pores and the communicating ports, and having proton conductivity.

2. The composite electrolyte membrane of claim 1,
wherein the polyether comprises polyether ether sulfone.

3. The composite electrolyte membrane of claim 1,
wherein the polyether comprises one selected from the group consisting of sulfonated polyether sulfone, sulfonated polyether ether ketone, sulfonated polyether ether sulfone, sulfonated polysulfone, and sulfonated poly(diphenyl-1,4-phenyleneoxide).

4. The composite electrolyte membrane of claim 1,
wherein the electrolyte material further comprises an aromatic hydrocarbon polymer having a first functional group expressing the proton conductivity.

5. The composite electrolyte membrane of claim 1,
wherein the electrolyte material has an ion-exchange capacity of at least 1 to 6 meq/g.

6. The composite electrolyte membrane of claim 1,
wherein the porous body is composed of a material that forms a sol composed of the inorganic substance.

7. The composite electrolyte membrane of claim 6,
wherein the material that forms the sol is colloid composed of the inorganic substance.

8. The composite electrolyte membrane of claim 1,
wherein the porous body comprises at least one selected from the group consisting of silica, titania, zirconia, and tantalum oxide.

9. The composite electrolyte membrane of claim 1, further comprising:
a second proton-conductive functional group formed on surfaces of the spherical pores of the porous body.

10. The composite electrolyte membrane of claim 9,
wherein a diameter of the spherical pore is within a range from 20 to 200 nm.

11. The composite electrolyte membrane of claim 10,
wherein the diameter is within a range from 50 to 150 nm.

12. The composite electrolyte membrane of claim 9,
wherein the second functional group comprises a functional group having a function as a Brønsted acid.

13. The composite electrolyte membrane of claim 12,
wherein the second functional group comprises at least one selected from the group consisting of a sulfonic acid group, a phosphoric acid group, and a carboxylic acid group.

14. The composite electrolyte membrane of claim 9,
wherein the second functional group is contained in a ratio of 0.2 to 2.8 mmol/g per unit weight of the porous body.

15. The composite electrolyte membrane of claim 14,
wherein the second functional group is contained in a ratio of 0.3 to 1.2 mmol/g per unit weight of the porous body.

16. The composite electrolyte membrane of claim 9,
wherein weight of the dried porous body per equivalent weight of the second functional group is within a range from 350 to 3600 g/eq.

17. The composite electrolyte membrane of claim 16,
wherein the weight of the dried porous body per equivalent weight of the second functional group is within a range from 890 to 2700 g/eq.
